(19) United States
(12) Patent Application Publication
(10) Pub. No.: US 2021/0148039 A1
(43) Pub. Date: May 20, 2021

(54) Mat with Placement Indicia for Sorting, Folding, and Organizing Laundry

(71) Applicant: Willaura Josephelynn Adams, Duluth, GA (US)

(72) Inventor: Willaura Josephelynn Adams, Duluth, GA (US)

(21) Appl. No.: 16/932,771

(22) Filed: Jul. 19, 2020

Related U.S. Application Data
(60) Provisional application No. 62/852,279, filed on May 23, 2019.

(51) Int. Cl. D06F 93/00; D06F 95/00

(52) U.S. Cl. CPC D06F 93/00; B41M 5/382; D06F 95/004

(57) ABSTRACT

A laundry organizing tool that comprises of placement indicia, imprinted on the surface of the tool, to facilitate a sorting, folding, and organizing method for laundry. The placement indicia are various terms, shapes, and illustrations that act as placement guides for the sorting, folding, and organizing of the consumer's laundry. The placement guides can be depicted on a porous or non-porous surface. The primary utility system of the laundry organizing tool is a mat. The mat is designed for placement on the floor, furniture, bed, sofa, table, and/or anywhere the consumer chooses to sort or fold laundry. In most instances, the laundry organizing tool is a mat that can be placed in the washing machine with laundry.

### CROSS REFERENCE TO RELATED APPLICATIONS (IF ANY)

62/852,279

Non-Provisional Patent Application

### STATEMENT OF FEDERALLY SPONSORED RESEARCH OR DEVELOPMENT (IF ANY)

Not Applicable

### THE NAMES OF THE PARTIES TO A JOINT RESEARCH AGREEMENT IF THE CLAIMED INVENTION WAS MADE AS A RESULT OF ACTIVITIES WTHIN THE SCOPE OF A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC. THE TOTAL NUMBER OF COMPACT DISC INCLUDING DUPLICATES AND THE FILES ON EACH COMPACT DISC SHALL BE SPECIFIED.

Not Applicable

### BACKGROUND OF THE INVENTION

### Field of the Invention

The present invention relates to a laundry organizing tool, that involves a system and method for sorting and folding laundry. This system and method uses placement indicia in the form of terms, shapes, and illustrations to use as placement guides during the laundry folding process. In particular, the invention relates to a laundry organizing mat for sorting and folding laundry, that is configured so as to accommodate a workable length of a flat surface, and provided with functional indicia to facilitate the sorting, organizing, folding, and placement of clothing, accessories, wearable gear, toiletries, household linens, and other items.

### Background

Often times laundry is a daunting task which gets done at the last minute, leading to a large laundry pile. The laundry which was in a clean state is now subject to unwanted bacteria, dust, and stains.

There are also situations where someone has so much laundry, that the laundry no longer fits in baskets, but is overflowing on unsanitary places such as the couch, kitchen table, floor, bed comforter, and ironing board. These surfaces harbor microscopic germs and bacteria that contaminate the laundry once the clothing pile has been placed on it.

Placing freshly washed laundry on a non-clean surface can also lead to unwanted stains, soil transfer, and undesirable filth.

Even if a pile has been kept properly in a basket, when it is time to fold, unsanitary and unorganized methods follow. The clutter of laundry dampens the consumer's mood and reduces the ability to focus, which is why folding always seems to be an unsettling task.

Traveling can also pose issues to contaminating clean clothing. Generally, when one packs luggage they do not have a tool to use to keep their laundry sanitary once they reach their destination. If someone is lodging in a hotel, shared accommodations, or public lodging space, it appears that these areas are indeed clean. However, the public lodging environment has been used several times over, by different variations of individuals. It is no longer ideal to unpack luggage on the duvet comforter, office table, top of the dresser drawer, or couch. These surfaces harbor millions of germs and bacteria, after being used repeatedly by lodging guests.

There currently does not exist a mat or table that acts as a protective barrier between two surfaces when folding laundry. Nor does there exist a mat or table which has imprinted indicia to use as placement guides to assist in the process of sorting and organizing laundry.

Accordingly, there is a need for a universally usable laundry organizing system which aids the consumer with sorting, organizing, and folding laundry. Moreover, there is a need for a universally usable mat that prevents clean laundry from being soiled, stained, or contaminated with germs. The present invention fulfills these needs and provides additional advantages.

### BRIEF SUMMARY OF THE INVENTION

The present invention provides a method for guiding a consumer in the practice of sorting and folding laundry, on a laundry organizing tool, which has patterned designs on its surface, also known as placement indicia, to facilitate the sorting and folding process for the consumer.

The laundry organizing tool, can be a mat or table, which is constructed to assist a consumer with sorting and folding laundry using a classification system based on the type of garment/item. The placement indicia imprinted on the outer surface of a mat is the primary form of the laundry folding system.

In a particularly preferred embodiment of the invention, the mat has a rectangular configuration. The patterned design includes placement indicia positioned from the center of the mat, comprising the full upper surface of the mat.

According to one feature of the present invention, a rectangular shaped mat is provided with a patterned design of placement indicia centrally displayed, and configured to aid the consumer in the practice of sorting, folding, and organizing items, particularly clothing articles or fresh dried laundry, by using the imprinted indicia as placement guides to ease the process.

According to a second feature of the present invention, a rectangular shaped mat is provided with a patterned design of placement indicia centrally displayed, in order to act as a barrier between clean items, particularly laundry or clothing items, and a planar surface, so that these clean items do not become contaminated by the surface during the process of folding.

According to a third feature of the present invention, a rectangular shaped mat is provided with a patterned design of placement indicia centrally displayed, in order to act as barrier between clean items that are carried in luggage for traveling, particularly the consumer's personal travel items or clothing items, so that these clean items do not become contaminated during the process of unpackaging luggage, as most public lodging to include hotels, hostels, homestays, public accommodations, are contaminated with microscopic germs through the medium of office desks, sofas, duvet covers, bedsheets, dresser drawers, and countertops.

According to a fourth feature of the present invention, a rectangular shaped table is provided with a patterned design of placement indicia centrally displayed, and configured to aid the consumer in the practice of sorting, folding, and organizing items, particularly clothing articles or fresh dried laundry, by using the imprinted indicia as placement guides to ease the process.

Further scope of applicability of the present invention will become evident from the precise description given henceforward. Notwithstanding, it should be presumed that the precise description and specific examples, while indicating preferred embodiments of the invention, are given by way of illustration only.

### BRIEF DESCRIPTION OF THE SEVERAL VIEWS OF THE DRAWING (IF ANY)

The present invention will now be more fully understood from the detailed description given hereinbelow, by way of example, with reference to the accompanying drawings which are given by way of illustration only, and are not limitative of the present invention, and wherein:

FIG. 1 is a top plan perspective of a preferred embodiment of the laundry organizing tool, in the form of a mat, with generic placement indicia.

FIG. 2 is a top plan perspective of a preferred embodiment of the laundry organizing tool, in the form of a mat, with placement indicia reflecting clothing items for women.

FIG. 3 is a top plan perspective of a preferred embodiment of the laundry organizing tool, in the form of a mat, with placement indicia reflecting clothing items for men.

FIG. 4 is a top plan perspective of a preferred embodiment of the laundry organizing tool, in the form of a mat, with placement indicia reflecting clothing items for men.

FIG. 5 is a top plan perspective of a preferred embodiment of the laundry organizing tool, in the form of a mat, with placement indicia reflecting children's clothing items.

FIG. 6 is a top plan perspective of a preferred embodiment of the laundry organizing tool, in the form of a mat, with placement indicia reflecting towel items.

FIG. 7 is a top plan perspective of a preferred embodiment of the laundry organizing tool, in the form of a mat, with placement indicia reflecting travel items.

FIGS. 8a and 8b demonstrate how laundry is piled, folded, and organized using placement indicia.

FIGS. 9a to 9c demonstrate how laundry is piled, sorted, folded, and organized using placement indicia.

FIGS. 10a to 10d demonstrate how a child uses the laundry organizing mat to pile and sort items using placement indicia.

FIG. 11 shows how the laundry organizing mat is placed on a bed surface to act as a contamination barrier.

FIGS. 12a and 12b show how the laundry organizing mat is placed on a sofa surface and a table surface to act as a contamination barrier between the laundry and the surface.

FIG. 13 shows how the laundry organizing mat is placed on a dining room table surface to act as a contamination barrier.

FIG. 14 is a side perspective view of the laundry organizing tool, in the form of a table, with generic placement indicia imprinted on its outer surface.

FIG. 15 is a side perspective view of the laundry organizing tool, in the form of a i at, with a closure attached to 3 sides to create a makeshift laundry bag for sanitary transport to the next folding surface.

FIG. 16 is a top plan perspective of a preferred embodiment of the laundry organizing tool, in the form of a mat, with placement indicia written in Spanish reflecting clothing items for women.

### DETAILED DESCRIPTION OF THE INVENTION

### Detailed Description of the Preferred Embodiments

The present invention will become more wholly understood from the detailed description given hereinbelow and the accompanying drawings which are given by way of illustration, and are not meant as a limitation of the present invention. For example, features illustrated or described as part of one embodiment can be used with another embodiment to produce still a third embodiment. It is advised that the present invention include these, as well as other modifications and variations, and wherein:

The following definitions set forth the parameters of the present invention.

As used herein, the term “placement indicia” refers to distinguishing marks or symbols that are imprinted on the visible surface of the mat or table. The placement indicia depicts placement guides, types of common clothing, and household items through the use of terms, shapes, and illustrations. This produces an organizing system detailing the sorting of laundry by classification of garment.

As used herein, the term “placement guides” refers to lines, shapes, terms or illustrations that create an outline of pre-determined spaces on the visible surface of the mat or table. The placement guides use the pre-determined spaces to indicate a given area for a consumer to place items during the sorting and folding process. The placement guides are designed based on a classification system to distinguish an array of items based on item type or style.

In view of the aforementioned and the description provided herein, the following specifications will clearly set forth the advantages the present invention provides to the consumer.

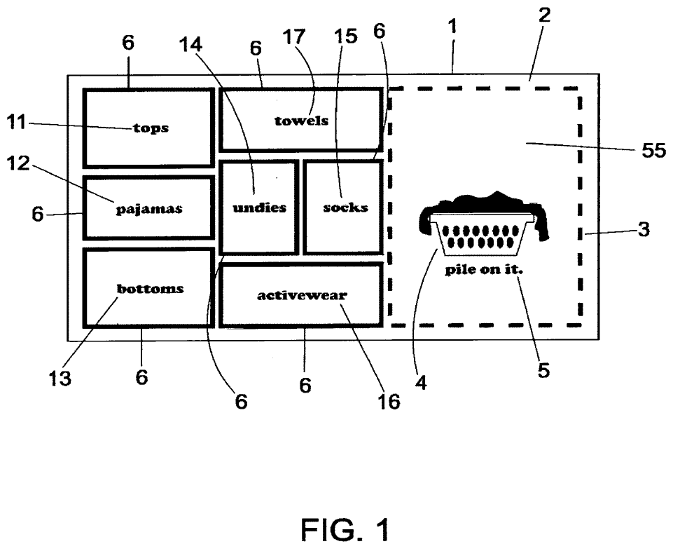

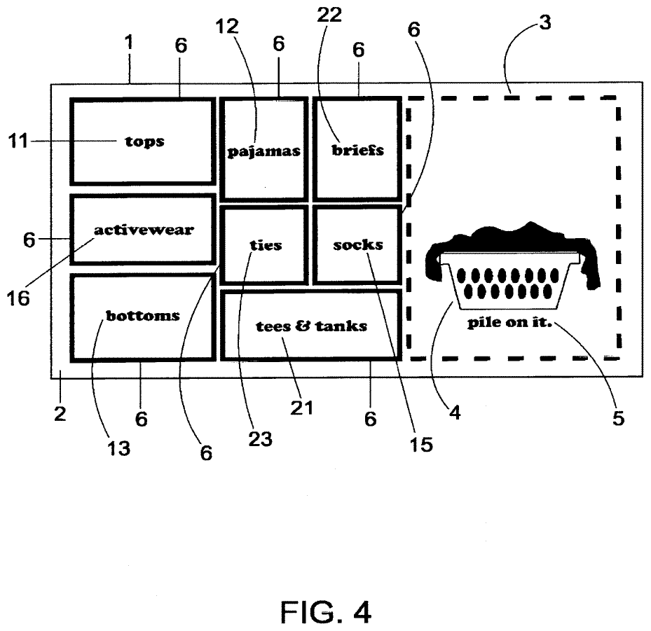

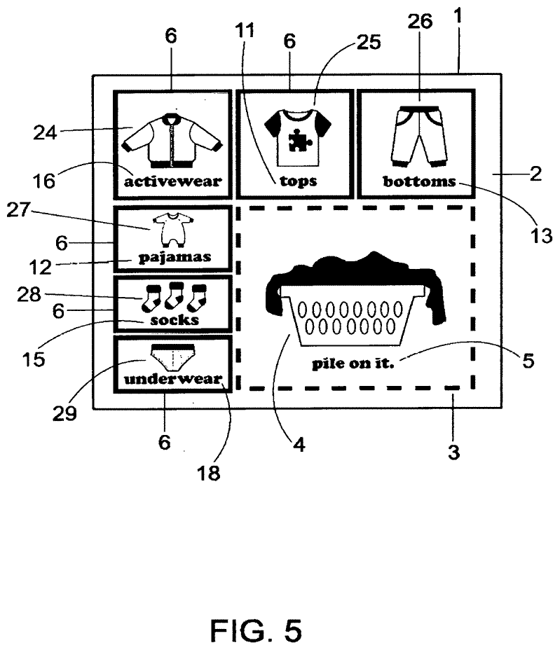

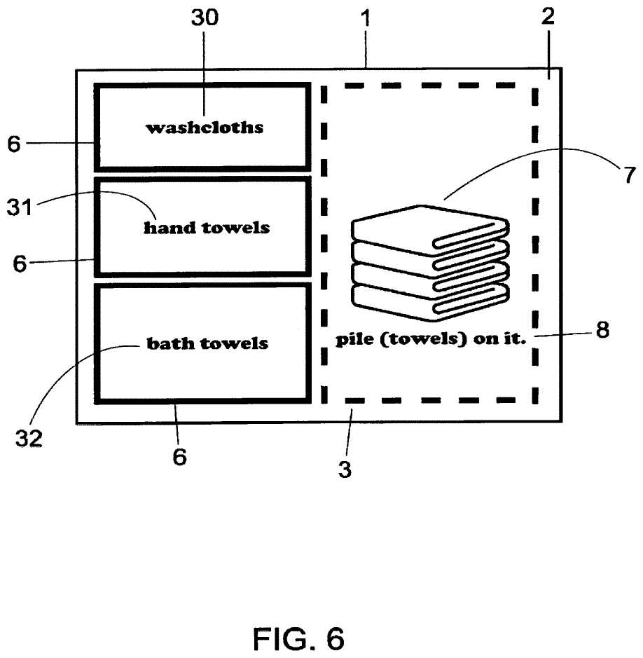

As shown in FIG. 1 through FIG. 7, the present invention now provides a laundry organizing mat with placement indicia. The laundry organizing mat 1 includes an upper surface shown at 2 and may include a bottom surface. The placement indicia are preferably imprinted on the upper surface 2, however, it is to be understood that placement indicia may also be imprinted on the bottom surface.

The upper surface 2 of the mat is planar and will generally be a polyester textile shell, while the bottom layer is a stronger textile weave, support netting, or foam pad to aid the tool in being more medium-to-heavy weight to prevent sliding. The mat is made out of any fabric or utility material to include canvas, cotton, and polyester.

The thickness of the mat may be from 1/16″ to 1″ depending on the material from which it is manufactured. The mat is portable and can be folded up. The mat is machine washable.

The laundry organizing mat typically has a rectangular shape, generally being 24″ to 32″ in width and 28″ to 64″ in length. This laundry organizing mat may be provided in different colors based upon consumer preference. The laundry organizing mat may also have any shape other than rectangular, to include circular as well as a variety of shapes and sizes.

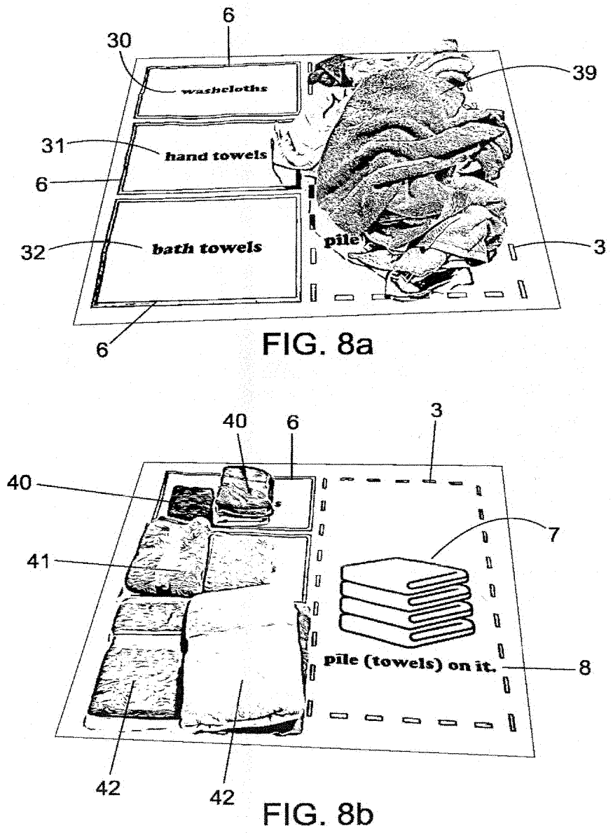

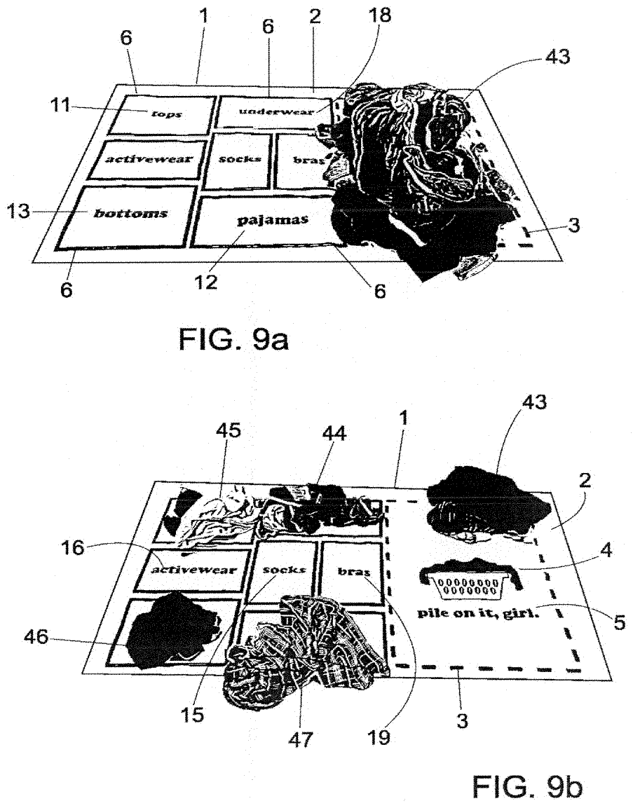

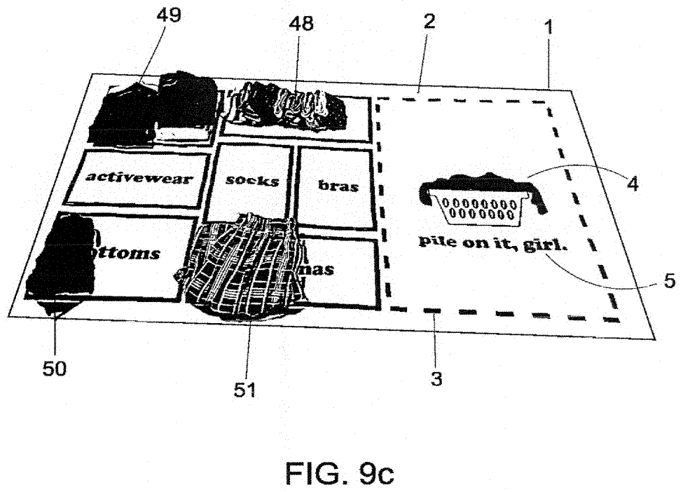

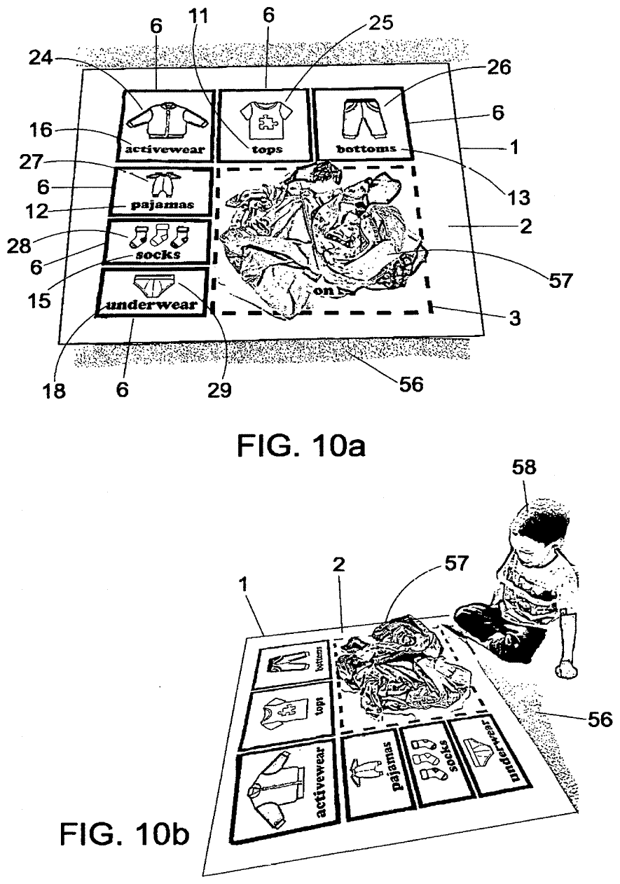

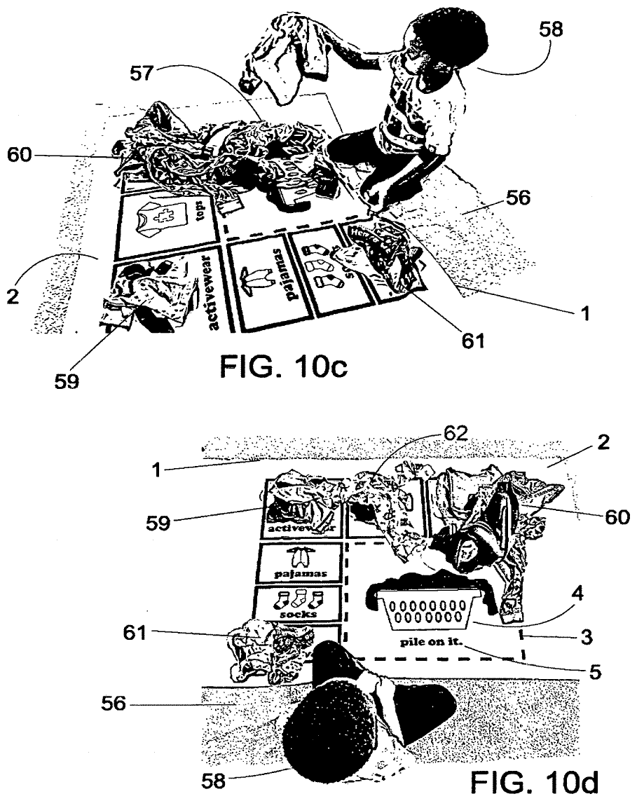

The laundry organizing mat holds a full pile of dry laundry as shown in FIG. 8a, FIG. 9a, and FIG. 10a, allowing for items to be sorted on top of or within the apparatus. The laundry organizing mat works best after a consumer washes and dries laundry, and is the next action to take before folding the clean laundered items.

Further in relation to this, it is to be understood that the laundry organizing tool can also possess the embodiment in the form of a table.

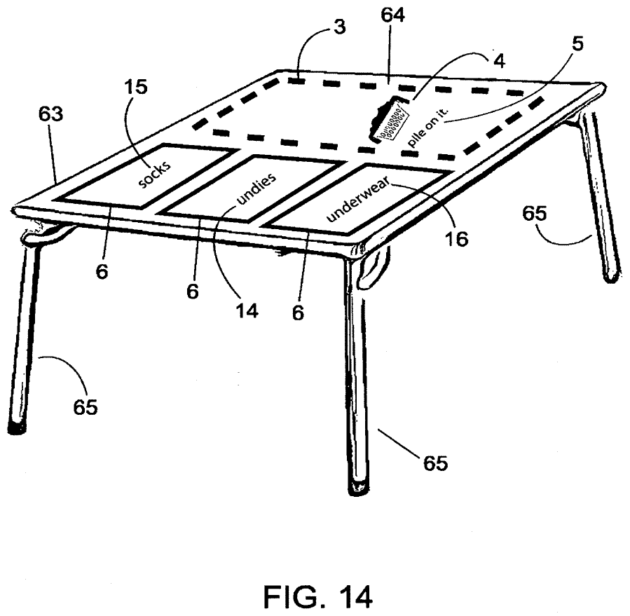

As shown in FIG. 14, the present invention now provides a laundry organizing table with placement indicia. The laundry organizing table 63 includes an upper surface shown at 64. The placement indicia is imprinted on the upper surface 64.

The laundry organizing table generally has a rectangular shape. This laundry organizing table may be provided in different colors based upon consumer preference. The laundry organizing table may also have any shape other than rectangular, to include circular as well as a variety of shapes and sizes. The laundry organizing table can be stationary, collapsible, or movable. As illustrated in FIG. 14 the table may have collapsible table legs 65 to make it easier for consumer use.

The organizing system detailing the sorting of laundry by classification of garment type may be depicted on top of a non-porous or porous surface. These surfaces include, but are not limited to, table top, wood, rubber, steel, plastic, linens, tiles, countertops, etc. The organizing system detailing the sorting of laundry by classification of garment will be hereinafter called placement indicia.

Before the present invention, folding and sorting laundry was a guessing estimate. There were no pre-determined or illustrated guides to assist a consumer in sorting laundry. There were no pre-determined or illustrated guides to assist a consumer in organizing laundry.

The placement indicia 3 through 6 may be rectangular lines or defined spaces showing where to place a garment or item during the folding process. These placement guides provide a frame of reference for the consumer, as to where to sort or place a garment. As shown in FIG. 1 through FIG. 7 preferably the start of the organizing system are scored lines that form a rectangular shape 3, then display a space for the user to pile the laundered clothing pile 55. This space 55 is big enough to hold small to larger amounts of clothing, depending on the size of laundry organizing mat chosen by the consumer. It is preferred that consumer will place pile of unsorted laundry in the space 55, which is generally on the far left end or far right end of the laundry organizing tool. Inside the space is imprinted placement indicia 4, 5, 7, 8, 9, 10, by terms or illustrations, which shows the consumer what to do. In FIG. 1 through FIG. 5, the terms “pile on it” 5, direct consumer to pile the laundry on to top of the space 55. In FIG. 1 through FIG. 5, a laundry basket icon 4, directs the customer to place the contents of the laundry basket in that defined space 55.

The consumer may choose to pile laundry onto the space as intended by the placement indicia, or they may leave the garments in a nearby laundry basket. In FIG. 1 through FIG. 7, there is placement indicia designed of several boxes of different widths and lengths 6, which act as placement guides for the sorting process. Each placement guide 6, has a category displayed by terms centrally located within the solid rectangular lines, as shown in FIG. 1 through FIG. 7. The terms shown in FIG. 1 through FIG. 7 are 11 through 23, 25 through 29, 33 through 38 to aid user in where to sort specific types of garments. If the garment is not illustrated or specified in the placement indicia, then the consumer may place the item inside the solid rectangular lines with a related item, or the consumer may sort the item in a different area which contains no specific placement guides at all, hence the “pile on it” area 55.

Any number of placement indicia (placement guides) may be imprinted on the visible surface of the laundry organizing mat 1. Further, any combination of solid-line, scored-line, broken-line, and pictorial indicia may be used.

Several examples will now be given of how the placement indicia 11 through 38 can be used in practice. Particular reference will be given to FIG. 1 through FIG. 7 although it is understood that the examples described herein can be applied to the other designs as well.

The pattern designs provide enough indicia to accommodate all garment and item types. As the garment or items can be placed on, past or before the indicia 3 through 38, or lines, any given consumer can properly organize his or her laundry at their preference.

In one example, a consumer may use the laundry organizing mat to fold laundry and organize the laundry in categories. The placement indicia in FIG. 8a and FIG. 8b shows terms for common household linen items, specifically towels. The consumer will pile 39 the unsorted load of towels onto the mat over the “pile (towels) on it” placement guide 8. Next, the consumer will pick up a towel, fold the towel, then place the towel in the designated placement guide 6. All washcloths will be placed on top of the placement guide 6 labeled “washcloths” 30. All hand towels will be placed on top of the placement guide 6 labeled “hand towels” 31. All bath towels will be placed on top of the placement guide 6 labeled “bath towels” 32. In FIG. 8b, the folded towels are now organized and stacked within the corresponding placement guides. The folded washcloths 40 are neatly stacked inside the placement guide 6, over the placement indicia “washcloths” 30. The folded hand towels 41 are neatly stacked inside the placement guide 6, over the placement indicia “hand towels” 31. The folded bath towels 42 are neatly stacked inside the placement guide 6, over the placement indicia “bath towels” 32.

In a second example, a consumer may use the laundry organizing mat specifically to sort laundry, The placement indicia in FIG. 9a, FIG. 9b, and FIG. 9c shows terms for common garment items. The consumer will pile 43 the unsorted load onto the mat over the “pile on it” placement guide 5. Next, the consumer will sort out the garments from the pile, one by one, and place the garment into the corresponding placement guide as shown in 44-47. For instance, if the consumer has a bra, then the consumer will place the bra over the placement guide that displays the term “bras” 19. If the consumer has a shirt, then the consumer will place the shirt over the placement guide that displays the term “tops” 11. If the consumer has panties, then the consumer will place the panties over the placement guide that displays the terms “underwear” 18. If the consumer has a sock, then the consumer will place the sock over the placement guide that displays the terms “socks” 15. The consumer will complete this process for each garment, until the pile 43 has been completely sorted. All of the underwear will sort into a pile 44. All of the tops will sort into a pile 45. All of the bottoms will sort into a pile 46. All of the pajamas will sort into a pile 47.

In a third example, a consumer may use the laundry organizing mat specifically to fold laundry. The placement indicia in FIG. 9c shows terms for common garment items. The consumer may pile the unsorted load onto the mat over the “pile on it” placement guide 5. Next, the consumer will pick up a garment from the pile, one by one, and fold the garment. Then, the consumer will place the folded garment into the corresponding placement guide, as shown in 48-51. For instance, if the consumer has underwear, then the consumer will place the folded underwear 48 over the placement guide that displays the term “underwear” 18. If the consumer has shorts, then the consumer will place the folded shorts 50 over the placement guide that displays the term “bottoms” 11. If the consumer has a t-shirt, then the consumer will place the folded t-shirt over the placement guide that displays the terms “tees & tanks” 21, If the consumer has a pair of leggings, then the consumer will place the folded leggings over the placement guide that displays the terms “activewear” 16. The consumer will complete this process for each garment, stacking the folded garments on top of one another, inside the lines of the designated placement guide 6. The consumer may also sit the folded garments next to each other. The placement of the folded garments can be done inside or around the lines of the imprinted placement guide 6. The consumer will continue to organize the folded laundry, until the initial pile 43 and has been completely folded. All of the folded underwear will be placed in a stack 48. All of the folded tops will be placed in a stack 49. All of the folded bottoms will be placed in a stack 50. All of the folded pajamas will be placed in a stack 51.

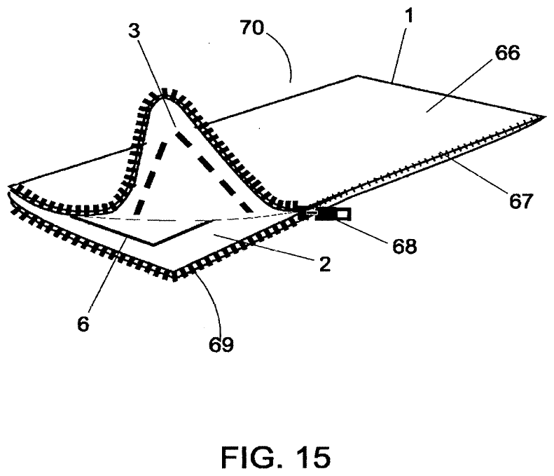

In a fourth example, a consumer may use the laundry organizing mat specifically to transfer laundry from the dryer to a surface whilst keeping the laundry uncontaminated. The consumer will take the action of removing the mat from the dryer (first), then zipping it around the edges, with placement indicia right side in and wrong side out, as shown in FIG. 15. Then the consumer will stuff the remaining garments inside the makeshift bag, and place the makeshift bag 70 down on a planar surface (such as a bed). The longest sides of the makeshift bag will be down, as the bag is not to be stood up prior to unzipping. Then the consumer will unzip the makeshift bag, and lay the sides flat, smoothing it out to fabricate a flat mat. The stuffed laundry now forms a pile without garments ever being contaminated.

In a fifth example, a consumer may use the laundry organizing mat specifically to organize laundry before putting the items away to a respective location (closet, drawer, shelf, rack). The placement indicia in FIG. 1 through FIG. 7 shows terms for common garment items. The consumer may pile the unsorted load onto the mat over the “pile on it” placement guide 5. Next, the consumer will sort or fold laundry, then place the item in the space of the coordinating placement guide 6 that relates to the term or illustration 11-38 that describes the item. For example, if the consumer sorts out a pair of underwear, then the consumer will place or stack the underwear in or around the placement guide 6 area marked for panties, boxers, undies, or underwear, or an illustrated underwear design. If the consumer sorts out a pair of pants, then the consumer will place or stack the pants in or around the placement guide 6 area marked for bottoms or illustrated pants design. The consumer will complete this process for each garment, stacking the folded garments on top of one another, inside the lines of the designated placement guide. The consumer may also place the folded garments next to each other. The placement of the folded garments can be done inside or around the lines of the imprinted placement guide 6. The consumer will continue to organize the folded laundry. Once done, the consumer will put the items away by organized pile. For example, if the consumer keeps all the underwear and socks in one drawer, then the consumer will collect those items from the placement guides, then go put them away. The present invention makes the putting away process more efficient by using the placement indicia to organize the items in specific areas. This allows the user to conduct less trips, save energy, and complete the laundry task faster.

In a sixth example, a consumer may use the laundry organizing mat specifically to place laundry on protective barrier from another surface, as the consumer leaves the laundry piled on top of the laundry organizing mat until he or she is ready to put it away.

In a seventh example, a consumer may use the laundry organizing mat specifically to instruct a child how to sort and organize their own laundry and clothing items, as shown in FIG. 10a through FIG. 10d. With the use of pictorials and illustrations for those who are unable to read, a child 58 is able to sort and organize garments based off the item's similarities to the imprinted placement indicia. In FIG. 10b the child 58 begins with an unsorted laundry pile 57. Since the laundry organizer mat 1 acts as a barrier with contaminated surfaces, the mat 1 is placed on the floor 56 to keep the clean laundry clean. The child 58 begins to sort the laundry out from the unsorted laundry pile 57. Next, the child sorts any underwear 61 inside the “underwear” placement guides. The child sorts playtime clothes 59 into the “activewear” placement guides. The child sorts pants 60 into the “bottoms” placement guides. The child places shirts 62 into the “tops” placement guides. If the child has not learned how to read, the illustrations 24, 25, 26, 27, 28, 29 inside the designated placement guides assist the child in determining where to sort each item. Over time, small children may associate the written terms to the illustrations, which helps in learning how to spell and read certain words.

In an eighth example, a consumer may use the laundry organizing mat specifically to use in the laundromat as a protective barrier for the frequently used public folding tables, and as a sorting tool to complete the folding process faster.

In yet another embodiment, the laundry organizing mat may be manufactured with closures on three sides in order to create a makeshift laundry bag FIG. 15. This makeshift laundry bag 70 can be used for transport after the laundry has dried. The makeshift laundry bag 70 can also be used as storage, hence being closed up on all 3 sides in order to protect the laundry from contamination or germs. This is an additional feature of the laundry organizing mat to help keep clean laundry clean.

In this embodiment, a closure is added to all four sides of a rectangular shaped laundry organizing mat. Next, the mat is folded in half, the center fold lengthwise, and the imprinted area of the mat folded in. The imprinted area includes the placement indicia. The bottom surface 66 of the laundry organizing mat is now completely visible. Forthwith, any closure that does not destroy clothing fibers can be used, such as zippers, snaps, and buttons. After the mat is folded in half, the closures will connect on the three remaining sides.

As shown in FIG. 15, a zipper 68 is used to transform the laundry organizing mat 1 to produce a makeshift laundry bag 70. The consumer can zip and close the laundry organizing mat from the bottom center fold, then around to the longest side 67. Now, there remains an opening as shown in the unzipped part 69 of the makeshift laundry bag. The consumer will insert the laundry into the makeshift laundry bag through this opening. After the consumer is finished, the consumer is able to transport laundry to his or her preferred surface without contamination. Once at the surface, the consumer will place the laundry organizing mat flat down, with the closure sides facing the side perspective. Next, the consumer will unzip, unsnap, unbutton, or unclose the three sides. Then, the consumer will pull over the folded side of the laundry organizing mat to lay it flat on a planar surface. During this entire process, the laundry in transport is never contaminated, nor does it touch any other surface other than the laundry organizing mat.

A process used to manufacture the laundry organizing tool, in the form of a mat will now be described. The textile layers are provided. The outer surface may be white or colored.

The outer surface of the mat may be produced and manufactured from any bendable and flexible material such as but not limited to rubber, vinyl, leather, plastics, polymers, synthetic fibers, linens, natural cotton fibers, or any other material that can effectively act as a protective barrier from a contaminated surface.

The placement indicia can be carried by the laundry organizing tool, with tool being in mat form, in a variety of ways. The placement indicia may be integrally formed with the mat. The placement indicia can be applied to the mat in order to print the placement indicia on the mat. The placement indicia can be printed on the mat. The placement indicia can be applied to the mat.

The placement indicia may be applied by manufacturer or consumer. If placement indicia is applied by the manufacturer, the consumer will purchase the laundry organizing tool already complete with placement guides and placement indicia visibly imprinted on the outer surface.

If placement indicia is applied by the consumer, the consumer is able to purchase iron-on heat transfers in which the organizing tool is already complete with placement guides, and the consumer will use heat transfer pressure to apply placement indicia in the form of words, illustrations, and shapes. This will be applied in his or her home.

The placement indicia may be applied to the laundry organizing tool through a digital fabric printing method. One such method is dye-sublimation. Dye-sublimation is a computer printing technique that uses heat to transfer dye onto materials such as plastic, card, paper, or fabric. The placement indicia for the laundry organizing mat is printed on a special paper, then the paper is placed on top of the mat, heat pressure is applied and gases release the dye onto the top surface of the mat, which integrally forms the placement indicia to the surface. This process can also be done for the other embodiments of the laundry organizing tool, to include plastics, wood, and metals.

The placement indicia may be applied to the laundry organizing tool through an ink application method. One such method is screen printing. Screen printing is a printing technique where a mesh is used to transfer ink onto the laundry organizing mat, then a squeegee is moved across the screen to fill the open mesh areas with ink, and a reverse stroke cause screen to touch the top surface of the mat printing the placement indicia.

The placement indicia may be applied to the laundry organizing tool through direct-to-garment printing. Direct to garment printing is a process of printing directly on the laundry organizer mat, by feeding it through the printer, then specialized aqueous printer inks are sprayed onto the textile by the printhead, printing the placement indicia on the visible surface.

The placement indicia may be applied to the laundry organizing tool through a heat transfer application method. This method includes the heat transfer of vinyl, iron-on, appliques, heat transfer paper, and/or all types of vinyl polymers. The design would be cut on a sheet using a vinyl cutter, weeded out, and placed on the laundry organizing mat substrate. Next, heat is applied using a heat press or iron, and the heat pressure transfers the placement indicia on top of the mat.

The placement indicia may be applied to the laundry organizing tool through any printing method, that requires the transfer of ink or dye to a porous or non-porous surface.

The placement indicia may be applied to the laundry organizing tool through any hand drawn method, that requires the transfer of ink, dye, marker, or paint to a porous or non-porous surface.

The placement indicia may be applied to the laundry organizing tool through sewing, topstitching, or embroidery. The placement indicia can be formed by the thread itself, via topstitching or embroidery, or appliques can be sewn on to the mat.

Although the placement indicia 3 through 38 may be applied to the laundry organizing tool by only one of the aforementioned described processes, combinations of two or more of the aforementioned described processes may also be used. Furthermore, the placement indicia 3 through 38 may be applied to the laundry organizing tool by processes not explicitly stated herein.

When the laundry organizing tool is used before piling, sorting, and folding laundry, the placement indicia 3 through 38 may designate where the consumer organizes his or her laundry, with consumer using the placement indicia as placement guides.

The consumer can complete the folding process much faster and in a more efficient manner since the classification of garments and placement guides are clearly visible.

The use of the placement indicia method by the consumer relieves stress, declutters the mind, and helps user complete laundry folding tasks faster. As the consumer efficiently completes one basket of laundry, the consumer may complete more of the laundry in queue. The laundry organizing tool emphasizes completing the entire task due to these advantages.

The invention may also take the form of a method for instructing a person on how to sort, organize, fold, and put away laundry, where the placement indicia includes defined spaces for where to place certain garments, including the term(s) or image that describes said garment. The placement indicia may serve several functions for the user, as detailed below.

For a consumer, the placement indicia serves as a frame of reference to aid the consumer in where to place items during the sorting and folding process.

For a trainer, the placement indicia provides a frame of reference for instructing someone on how to sort and organize laundered garments or items. The trainer can be a parent, guardian, grandparent, sibling, or anyone who has established a personal system for using the laundry organizing mat.

For a child or teenager, the placement indicia can serve as a guide so that the young consumer can be instructed on how to properly sort, organize, and fold his or her items. The outlines, terms, and illustrations imprinted on the surface of the mat provide consistent reference points by which the trainer is able to model different positions and placements for laundered garments or items.

For a baby or toddler, the placement indicia may serve as a pictorial guide to aid the small child in identifying where to place his or her laundered garments or items. Small children who are unable to read can help in the folding process with the use of pictures and illustrations imprinted on the mat surface.

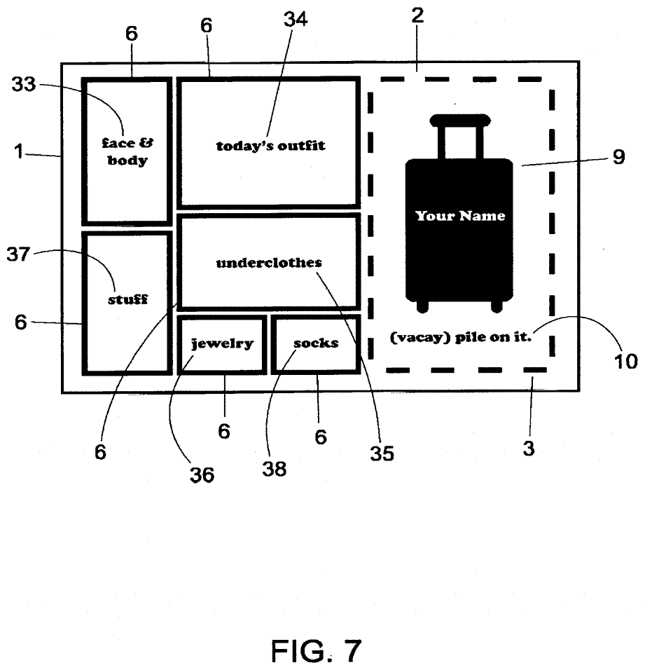

The laundry organizing mat can also be used for travel, as shown in FIG. 7. The travel size is made for short (or long term) travel, in which it can be packed neatly in a suitcase, and removed before the suitcase is unpacked. It will be used to prevent dean clothes from touching the contaminated surface of the duvet covers, comforters, or tables in a hotel room. These contaminated surfaces as described are not limited only to a hotel room, but may also include public lodging, campgrounds, shared accommodations, or any overnight stays in a residence that is not the consumer's home. The placement indicia 34 through 38 relate to items packed in luggage for a trip or vacation.

The laundry organizing mat can be used on the kitchen table, bed, sofa, floor, or any planar surface. Its purpose is to act as a protective barrier to folding CLEAN clothes on a dean surface.

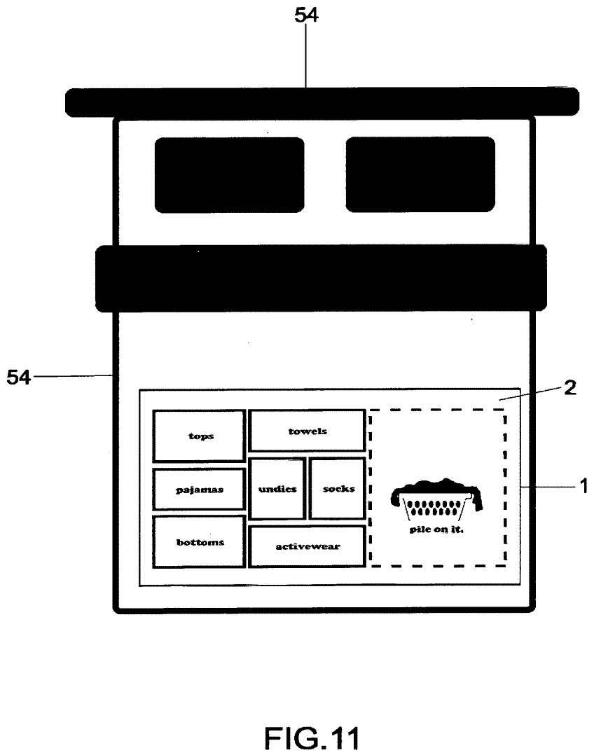

With reference to FIG. 11, the laundry organizing mat 1 is placed on top of a bed 54. Linens, comforters, sheets, and pillowcases can house germs, dust mites, and millions of colony-forming units of bacteria. The laundry organizing mat will act as a protective barrier between the dean laundry and the contaminated bed surface. The laundry will then be placed on the upper surface of the laundry organizing mat 1, away from the direct surface of the contaminated bed 54. Advantageously, the consumer will fold dean clothes on a clean surface.

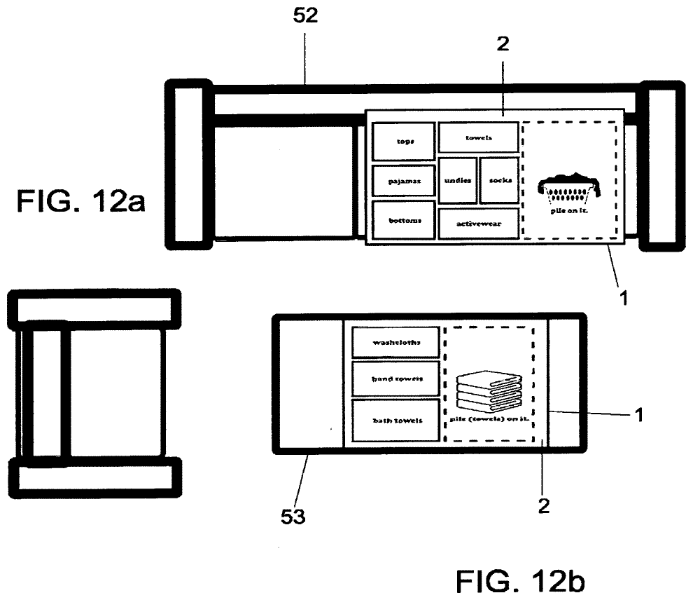

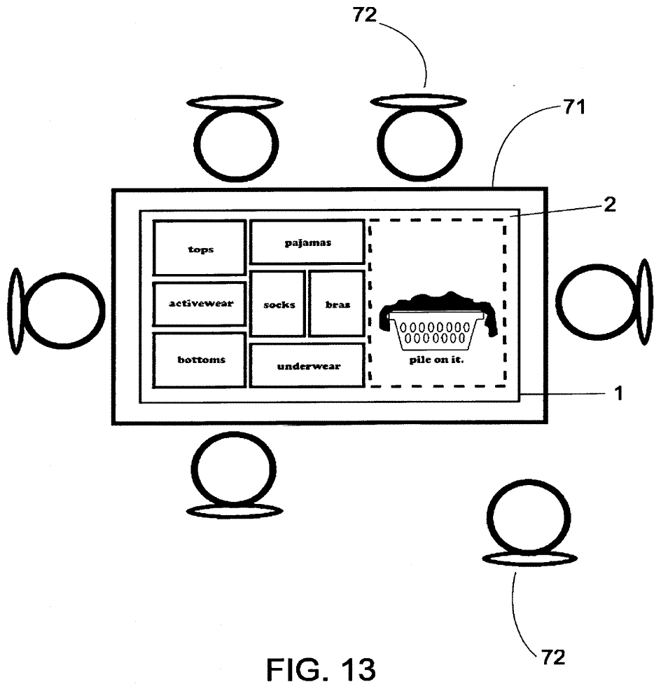

Referring now to FIG. 12a, the laundry organizing mat 1 is placed on top of a sofa seat 52. Sofa upholstery gets covered in many forms of bacteria as a result of un-sanitized hands, unclean worn clothing, and airborne viruses. The laundry organizing mat will act as a protective barrier between the laundry and the contaminated sofa surface, The laundry will then be placed on the upper surface of the laundry organizing mat 1, in relation to the placement guides, away from the direct surface of the contaminated sofa 52. Advantageously, the consumer will fold clean clothes on a clean surface.

Referring now to FIG. 12b, the laundry organizing mat 1 is placed on top of a coffee table 53. Tables are covered in many forms of bacteria as a result of contaminated items, spilled food, and unclean hands. The laundry organizing mat will act as a protective barrier between the laundry and the contaminated table surface. The laundry will then be placed on the upper surface of the laundry organizing mat 1, in relation to the placement guides, away from the direct surface of the contaminated table 53. As a result, the consumer will fold clean clothes on a clean surface.

The materials, patterned designs, placement indicia, placement guides, and functions of the rectangular laundry organization mat, are the same of that of a circular mat, triangular mat, and any ununiform shape mat. While the rectangular, circular, triangular, and ununiformed shapes have been described above, other mat shapes should be considered within the scope of the present invention.

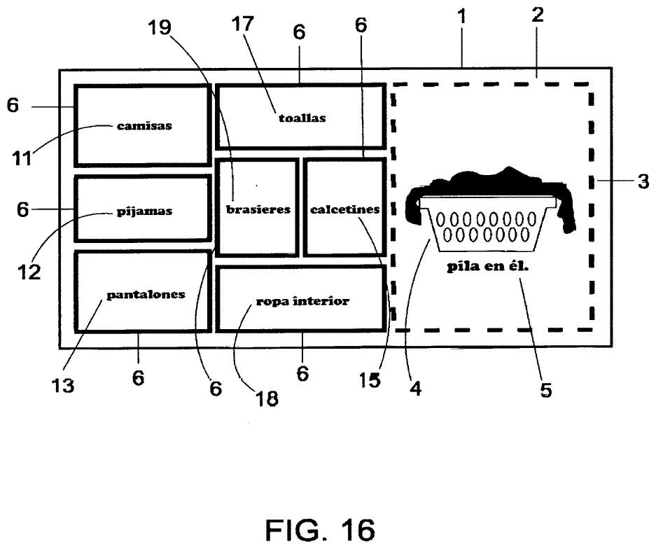

The placement indicia 3 through 38 may be imprinted or written in any language native to the consumer, and does not necessarily have to be displayed in English. The placement indicia 3 through 38 may also be imprinted with illustrations or pictorials related to the culture or heritage of the consumer. As shown in FIG. 16, the present invention now provides a laundry organizing mat 1 with placement indicia imprinted in Spanish.

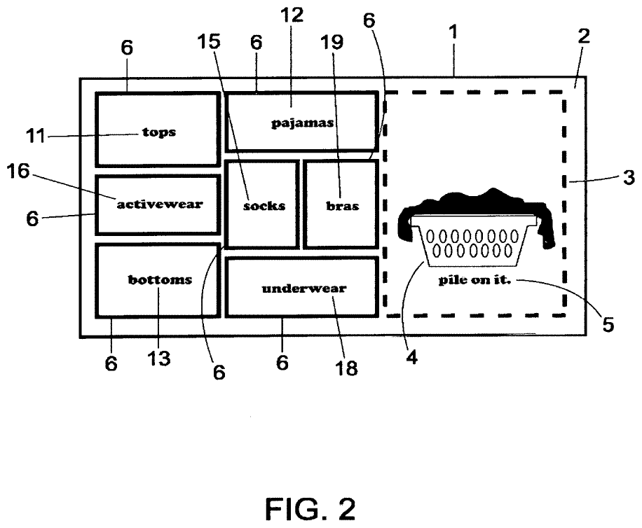

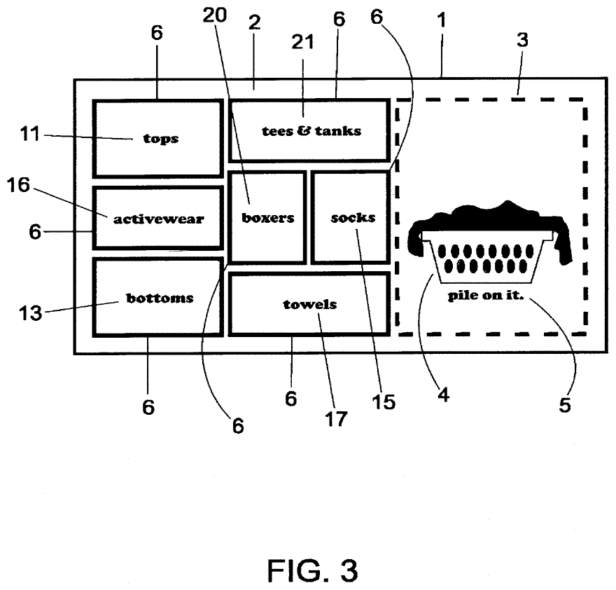

The placement indicia in Spanish version FIG. 16 is the same as other versions of the laundry organizing mat, with the only difference being the terms are written in another language. The depicted language is not limited only to Spanish, but can be imprinted in any language as understood by the consumer. For example, FIG. 16 placement indicia term “toallas” 17 has the same meaning as FIG. 1 and FIG. 3 placement indicia “towels” 17. The placement indicia term “ropa interior” 18 in FIG. 16, is identifying the same as placement indicia term “underwear” 18 in FIG. 2. The placement indicia term “pantalones” 13 in FIG. 16, is identifying the same as placement indicia term “bottoms” 13 in FIG. 1 through FIG. 4.

The skilled artisan will readily understand that the described embodiments and placement indicia are not solely limited to these variations, as they are merely shown as examples for the inventive purpose. Further, since modifications and changes will be obvious to those having ordinary skill in the art, it is not intended to limit the invention to the exact configuration indicated.

Therefore, it is to be understood that the parts of the invention include variations in size, materials, shape, imprinted design, placement indicia, and function. All suitable variations and modifications may be adopted, as many modifications of the present invention are possible in light of the above description. Moreover, the references and embodiments are not intended to be in any way limiting.

What is claimed:

1. A laundry organizing and sorting tool, comprising:
a mat having a porous or non-porous surface, wherein the mat has placement indicia that extends throughout the width and/or length of the mat in the form of terms, shapes, and illustrations used to identify laundry, clothing, or accessory items, printed on its surface to aid in organizing when folding laundry.
a table having a non-porous surface, wherein a table top has placement indicia that extends throughout the width and/or length of the table top in the form of terms, shapes, and illustrations used to identify laundry, clothing, or accessory items, printed on its surface to aid in organizing when folding laundry.
a user indicating placement indicia carried by the mat, wherein the user indicating placement indicia designates placement guides on where to place, sort, fold, and/or organizing laundry

2. The laundry organizing and sorting tool of claim 1 wherein the placement indicia includes placement guides showing where to distribute the items during the sorting process.

3. The laundry organizing and sorting tool of claim 1 wherein the tool is a mat.

4. The laundry organizing and sorting tool of claim 1 wherein the tool is a table.

5. The laundry organizing and sorting tool of claim 2 further indicating the placement indicia in the form of words, may be written or imprinted in any language as native to the consumer.

6. The laundry organizing and sorting tool of claim 2 further indicating the placement indicia in the form of illustrations, may be illustrated in any form to depict any object not limited to clothing, accessories, towels, shoes, socks, baby items.

7. The laundry organizing tool of claim 1 wherein the placement indicia shows how to distribute laundry through piling, sorting, and folding.

8. The laundry organizing tool of claim 1 can be used by any human or animal, ages 0 and up.

9. The mat of claim 3 wherein the mat is made of textile, rubber, foam, rubber, or plastic.

10. The mat of claim 3, which generally has a rectangular shape.

11. The mat of claim 3, can be used as a protective barrier by consumer laying mat on a table, sofa, bed mattress, ironing board, desk, countertop, floor, or any planar surface.

12. The mat of claim 3 is imprinted with functional placement indicia to facilitate the practice of sorting, organizing, and folding common laundered items.

13. The table of claim 4 is imprinted with functional placement indicia to facilitate the practice of sorting, organizing, and folding common laundered items.

14. The mat of claim 3, can be used for travel as a protective barrier on general surfaces in hotels, shared accommodations, and public lodging, by consumer laying mat on a table top, dresser drawer, office desk, sink counter, kitchen counter, bedspread, mattress, or any common surface in guest living spaces.

15. The mat of claim 3 has a zipper, snaps, buttons, hook & fastener, or any notion that forms a closure on three sides, to create a makeshift bag for laundry transport.

16. A method of forming a laundry sorting and organization tool, whether in the embodiment of a mat or a table, comprising:
Providing a porous textile layer (for a mat)
Providing a non-porous layer such as wood, or plastic (for a table)
Applying ink or printing through a (heat transfer method)
